(19) United States
(12) Patent Application Publication
(10) Pub. No.: US 2023/0240325 A1
(43) Pub. Date: Aug. 3, 2023

(54) Novel Food

(71) Applicant: The Protein Brewery B.V., Breda (NL)

(72) Inventors: Elisa Leune, Vaassen (NL); Kirsten Knobel, Breda (NL); Ap de Haan, Prinsenbeek (NL); Wilhelmus Theodorus Antonius Maria de Laat, Breda (NL)

(73) Assignee: The Protein Brewery B.V., Breda (NL)

(21) Appl. No.: 18/001,718

(22) PCT Filed: Jun. 23, 2021
(86) PCT No.: PCT/EP2021/067067

§ 371 Date: Dec. 14, 2022

(30) Foreign Application Priority Data
Jun. 23, 2020 (EP) 20181591.7

(51) Int. Cl. A23K 10/16; A23K 20/147; A23K 50/40; A23K 20/158; A23K 20/163; A23K 20/174

(52) U.S. Cl. CPC A23K 10/16; A23K 20/147; A23K 50/40; A23K 20/158; A23K 20/163; A23K 20/174

(57) ABSTRACT

The present invention relates to compositions comprising biomass of a thermophilic fungus for use as an ingredient in food products, beverages, pet foods or animal feed. Due to its nutritional composition the biomass of the thermophilic fungus can be used as a source of protein and/or amino acids, including essential amino acids; lipids, including oleic and linoleic acids; dietary fiber; choline and vitamins such as vitamin E; and minerals such as iron. The biomass of the thermophilic fungus is available as a compressed biomass cake or as a dried powder. As such the biomass of the thermophilic fungus is suitable as ingredient in meat replacers, and in hybrid meat products. In the form of dried powder the biomass of the thermophilic fungus can be easily mixed with other ingredients to produce bakery products such as bread or soups.

### FIELD OF THE INVENTION

The present invention relates to the fields of food supplements and replacements for use by both human food and animal feed.

### BACKGROUND OF THE INVENTION

Demand for edible products that can provide a high protein content which is drawn from a non-animal source is increasing. Driven by increasing awareness of personal health, edible products that include non-animal sourced components such as proteins and fibers are considered as a healthier alternative to animal protein based products. In particular, there is growing demand for edible meat substitutes that mimic meat in its composition and texture but are composed of non-animal components, which can reduce reliance animals such as cows, and reduce the carbon footprint posed by such animals.

Single-cell proteins (SCP) are an interesting alternative to meat proteins and as protein source in many other food applications such as breakfast cereals, bread, pasta, dairy, ice cream, chocolate, and soups. When fungal SCP is produced, it can be produced from sugar rich crops in a more sustainable way as compared to the production of meat protein, because SCP yields many more tonnes of protein per hectare compared to meat production and has lower nitrogen emission. One method for producing a dietary source of protein for human food or animal feed is to produce “single cell protein” (SCP) by means of fermentation (Suman et al., 2015, Int J. Curr. Microbiol. Appl. Sci., Vol 4, No 9, pp 251-262). Fermentation in this respect is understood as the microbial conversion of carbon-rich feedstocks into protein-rich products consisting of microbial cells such as bacteria, yeasts or fungi. The use of SCP as animal feed and food ingredient brings the further advantages that microbial cells have a high content of essential amino acids. Furthermore, in particular fungal cells can be very rich in trace elements and vitamins making the fermented feedstuffs very nutritive.

SCP is already used in food products for human consumption. For instance, Quorn™ comprises a mycoprotein produced as SCP by fermentation of the fungus Fusarium venenatum and contains Vitamin B1 (Thiamin), Vitamin B2 (Riboflavin), Vitamin B3 (Niacin), Vitamin B5 (Pantothenic acid) and Biotin (www.mycoprotein.org). Quorn™ is available in a variety of forms such as sausages, cutlets, burgers, patties, and strips, i.e. in meat analogue forms.

One problem in SCP production is the concentration of the SCP-biomass that is produced in the fermentation broth, particularly in the case of submerged fermentations with bacteria or yeasts. Another problem is the need for expensive enzymes to convert the cheap polymeric carbon sources to monomeric fermentable sugars. Furthermore, to avoid infection when using mesophilic microorganisms for SCP production sterile fermentation conditions need to be applied, which leads to prohibitive operational costs due to high capital investments and energy demands (WO2018/029353). Some of these issues have been addressed by using submerged fermentation with thermophilic fungi at high temperature and acidic pH, allowing the use of non-sterile conditions and by selecting thermophilic fungi that combine the favorable properties of good growth at high temperature and acidic pH with a sievable morphology and a high protein content (WO2018/029353).

However, there remains a need for non-animal protein sources that provide a wider range of applications in addition to the meat analogue forms currently available.

### SUMMARY OF THE INVENTION

In a first aspect, the instant invention relates to the use of a composition comprising biomass of a thermophilic fungus as a source of at least one of a) protein and/or an amino acid; b) a lipid; c) dietary fiber; d) choline and/or a vitamin; and e) a mineral, in at least one of a food product, a beverage, a pet food product and a feed product.

In a preferred use according to the invention, the composition comprising biomass of a thermophilic fungus is a cake obtainable in a process comprising the steps of a) growing a strain of a thermophilic fungus in submerged culture in a medium, b) recovery of the fungal biomass from the medium by at least one of sieving, filtration and decantation to produce a biomass cake, whereby preferably the dry matter concentration of the sieved, filtered or decanted biomass cake is at least 12% (w/v), and c) optionally, further drying the biomass cakes by pressing residual water out to obtain a biomass cake with a dry matter concentration of at least 20%, or, the composition comprising biomass of a thermophilic fungus is a dried powder obtainable by milling and further drying the biomass cake obtained in claim 2 to a biomass powder by warm air, by freeze drying, preferably under vacuum, or by flash drying, preferably to a water content of no more than 7% (w/w).

In a preferred use according to the invention, the fungal strain is a strain of a fungal genus selected from the group consisting of Rasamsonia, Talaromyces, Penicillium, Acremonium, Humicola, Paecilomyces, Chaetomium, Rhizomucor, Rhizopus, Thermomyces, Myceliophthora, Thermoascus, Thielavia, Mucor, Stibella, Melanocarpus, Malbranchea, Dactylomyces, Canariomyces, Scytalidium, Myriococcum, Corynascus, and Coonemeria, more preferably the genus is Rhizomucor, more preferably the strain is a Rhizomucor pusillus, most preferably the strain is Rhizomucor pusillus CBS 143028, or a strain that is a single colony isolate or a derivative thereof.

In a preferred use according to the invention, at least one of protein and the amino acid comprise an amino acid selected from the group consisting of aspartic, acid, asparagine, threonine, serine, glutamic acid, glutamine, proline, glycine, alanine, citrulline, valine, isoleucine, leucine, tyrosine, phenylalanine, lysine, histidine, arginine, cysteine, methionine and tryptophan, wherein preferably the amino acid is an essential amino acid, more preferably an essential amino acid selected from the group consisting of threonine, valine, isoleucine, leucine, phenylalanine, lysine, histidine, methionine and tryptophan, most preferably, in a vegetarian and vegan food product. In a more preferred use according to the invention, a) the biomass of the thermophilic fungus biomass is used as a (dietary) source of at least one of protein, amino acids and essential amino acids in a vegetarian or a vegan food product; b) the biomass of a thermophilic fungus is used as a (dietary) source citrulline in food, a food supplement or a beverage for sporting people; or c) the biomass of a thermophilic fungus is used as a source of protein, amino acids and essential amino acids in a pet food, preferably as alternative to standard animal or plant-based sources of protein, amino acids in pet food more preferably as sole source of protein and/or amino acids.

In a preferred use according to the invention, the biomass of the thermophilic fungus is used as a source of dietary fiber to enrich the fiber content of a food product selected from: i) a meat replacer; ii) a hybrid food product containing meat and non-meat ingredients; iii) a carbohydrate-rich food product; iv) a bakery product made with refined flours; and v) a pet food, wherein preferably the dietary fiber comprises chitosan. In a more preferred use according to the invention, the biomass of the thermophilic fungus is used as a source of dietary fiber in a human or pet food product to provide satiety, preferably to a human or pet in need of weight management or weight loss, wherein preferably the dietary fiber comprises chitosan.

In a preferred use according to the invention, the biomass of the thermophilic fungus is used as a source of choline in a vegan or vegetarian food product, or in a pet food, preferably a cat or dog food.

In a preferred use according to the invention, the biomass of the thermophilic fungus is used as a source of at least one of retinol, vitamin E, riboflavin, pyridoxine and folate, wherein preferably the biomass is used as a source of retinol in cat food.

In a preferred use according to the invention, the biomass of the thermophilic fungus is used as a source of iron, preferably, the biomass of the thermophilic fungus is used to replace soya as source of iron, more preferably, the biomass of the thermophilic fungus is used to replace soya as source of iron in a meat replacer.

In a preferred use according to the invention, the biomass of the thermophilic fungus is used as a source of at least one of mono-unsaturated fatty acids and poly-unsaturated fatty acids, preferably, the biomass thermophilic fungus is used as a source of at least one of oleic acid and linoleic acid.

In a preferred use according to the invention, the biomass of the thermophilic fungus is used for incorporating into a food product, a beverage, a pet food product and a feed product at a maximum level of 70% (w/w) and at a minimum level of at least 1% (w/w), in either cake or powder form.

In a preferred use according to the invention, the biomass of the thermophilic fungus is used as an ingredient for: a) a meat replacer, wherein the meat replacer comprises no more than 42% (w/w) of the biomass of the thermophilic fungus in cake form, or no more than 14% (w/w) of the biomass of the thermophilic fungus in powder form; b) a hybrid meat product, wherein the hybrid meat product comprises no more than 52% (w/w) of the biomass of the thermophilic fungus in cake form, or no more than 17.3% (w/w) of the biomass of the thermophilic fungus in powder form; c) a cereal-based food product, wherein the cereal-based food product comprises no more than 30% (w/w) of the biomass of the thermophilic fungus in cake form, or no more than 10% (w/w) of the biomass of the thermophilic fungus in powder form; d) a ready to eat meal food product, wherein the ready to eat meal food product comprises no more than 16% (w/w) of the biomass of the thermophilic fungus in cake form, or no more than 5.3% (w/w) of the biomass of the thermophilic fungus in powder form; e) a ready to eat soup, wherein the ready to eat soup comprises no more than 27% (w/w) of the biomass of the thermophilic fungus in cake form, or no more than 9% (w/w) of the biomass of the thermophilic fungus in powder form; and, f) a food product for sporting people, the food product for sporting people comprises no more than 70% (w/w) of the biomass of the thermophilic fungus in cake or in powder form.

In a second aspect, the invention pertains to a food product comprising a composition comprising biomass of a thermophilic fungus as defined herein, wherein the food product is: a) a meat replacer, wherein the meat replacer comprises no more than 42% (w/w) of the biomass of the thermophilic fungus in cake form, or no more than 14% (w/w) of the biomass of the thermophilic fungus in powder form; b) a hybrid meat product, wherein the hybrid meat product comprises no more than 52% (w/w) of the biomass of the thermophilic fungus in cake form, or no more than 17.3% (w/w) of the biomass of the thermophilic fungus in powder form; c) a cereal-based food product, wherein the cereal-based food product comprises no more than 30% (w/w) of the biomass of the thermophilic fungus in cake form, or no more than 10% (w/w) of the biomass of the thermophilic fungus in powder form; d) a ready to eat meal food product, wherein the ready to eat meal food product comprises no more than 16% (w/w) of the biomass of the thermophilic fungus in cake form, or no more than 5.3% (w/w) of the biomass of the thermophilic fungus in powder form; e) a ready to eat soup, wherein the ready to eat soup comprises no more than 27% (w/w) of the biomass of the thermophilic fungus in cake form, or no more than 9% (w/w) of the biomass of the thermophilic fungus in powder form; and, f) a food product for sporting people, the food product for sporting people comprises no more than 70% (w/w) of the biomass of the thermophilic fungus in cake or in powder form.

### DESCRIPTION OF THE INVENTION

### Definitions

Unless defined otherwise, technical and scientific terms used herein have the same meaning as commonly understood by one of ordinary skill in the art to which this disclosure belongs. One skilled in the art will recognize many methods and materials similar or equivalent to those described herein, which could be used in the practice of the present invention. Indeed, the present invention is in no way limited to the method.

For purposes of the present invention, the following terms are defined below.

As used herein, the term “and/or” indicates that one or more of the stated cases may occur, alone or in combination with at least one of the stated cases, up to with all of the stated cases.

As used herein, with “At least” a particular value means that particular value or more. For example, “at least 2” is understood to be the same as “2 or more” i.e., 2, 3, 4, 5, 6, 7, 8, 9, 10, 11, 12, 13, 14, 15, . . . etc.

The word “about” or “approximately” when used in association with a numerical value (e.g. about 10) preferably means that the value may be the given value (of 10) more or less 0.1% of the value.

The term “single cell protein” will be abbreviated “SCP” and is herein understood to refers to biomass consisting essentially of cells of organisms that exist in unicellular, or single cell, state, including unicellular bacteria, yeasts, fungi or algae, and which biomass, preferably in dried form, is suitable as dietary source of protein or protein supplement in human food or animal feed.

“Fungi” are herein defined as eukaryotic microorganisms and include all species of the subdivision Eumycotina (Alexopoulos et al., 1962, In: Introductory Mycology, John Wiley & Sons, Inc., New York). The term fungus thus includes both filamentous fungi and yeast. “Filamentous fungi” are herein defined as eukaryotic microorganisms that include all filamentous forms of the subdivision Eumycotina and Oomycota (as defined by Hawksworth et al., 1983, In: Ainsworth and Brisby's Dictionary of the Fungi. 7^{th} ed. Commonwealth Mycological Institute, Kew, Surrey). The filamentous fungi are characterized by a mycelial wall composed of chitin, cellulose, glucan, chitosan, mannan, and other complex polysaccharides. Vegetative growth is by hyphal elongation and carbon catabolism is obligately aerobic. A thermophilic fungus for use in the invention is a fungus that grows at a temperature of at least 45° C., sometimes even higher than 56° C.

The term “fermentation” or “fermentation process” is herein broadly defined in accordance with its common definition as used in industry as any (large-scale) microbial process occurring in the presence or absence of oxygen, comprising the cultivation of at least one microorganism whereby preferably the microorganism produces a useful product at the expense of consuming one or more organic substrates. The term “fermentation” is herein thus has a much broader definition than the more strict scientific definition wherein it is defined as being limited a microbial process wherein the microorganism extracts energy from carbohydrates in the absence of oxygen. Likewise, the term “fermentation product” is herein broadly defined as any useful product produced in a (large-scale) microbial process occurring in the presence or absence of oxygen.

The term “TOTOX value”, an abbreviation for total oxidation value, is understood to indicate oxidative load to which a fat has been exposed. The TOTOX value is a dimensionless number used to describe the total oxidative load to which a fat has been exposed. The value is calculated as the sum of the anisidine value and twice the peroxide value. Anisidine value (AnV) is a measure of aldehyde production during oxidation of fats. The value expresses the absorbance of fat reacted with p-anisidine, trivial name for p-methoxyaniline, under specified conditions. It is used to characterize the oxidative history of fat because aldehydes normally originate from oxidation of unsaturated fatty acids. Peroxide value (PV) is a measure of the extent of oxidation of a fat or oil. The value indicates the quantity of oxidized substances, normally hydroperoxides, which liberate iodine from potassium iodide under specified conditions. PV is expressed in milliequivalents of active oxygen per kg fat (Beare-Rogers et al., Lexicon of lipid nutrition (IUPAC Technical Report), 2009 DOI: 10.1351/pac200173040685). Oils with a TOTOX value under 80 have been described as having a good flavor evaluation (JP2014054248).

### DETAILED DESCRIPTION OF THE INVENTION

The inventors have found that biomass derived from a thermophilic filamentous fungus such as Rhizomucor pusillus strain, which is produced through a fermentation process during which simple carbohydrates and non-organic nitrogen sources are converted to a high nutritional value biomass, can be compressed (referred to as ‘cake’) and eventually dried to obtain a powder. The thus obtained fungal biomass is considered a novel food within the European Union (EU) if its source, for example Rh. pusillus, has no history of human consumption within the EU. The fungal biomass in e.g. cake and powder forms can be used as an ingredient in various food categories at different use levels. Thanks to its texture, the fungal biomass of the invention provides a versatile ingredient for many food products. The fungal biomass in cake form represents a valuable ingredient for meat replacers and hybrid meat products. The fungal biomass in its powder form can be easily mixed with other ingredients to produce bakery products such as bread, or soups, thanks to its flour-like texture. Also, the fungal biomass of the invention can be used as feed material, being an alternative to, or improving the nutritional value of feed of animal and vegetal origin.

In addition, the inventors have found that the fungal biomass of the invention contains a number of valuable nutritional components and as such can be used as a dietary source for these components.

In a first aspect, the invention therefore relates to the use of a composition comprising biomass of a thermophilic fungus as a source of at least one of a) protein and/or an amino acid; b) a lipid; c) dietary fiber; d) choline and/or a vitamin; and e) a mineral; in at least one of a food product, a beverage, a pet food product and a feed product. Preferably, the composition is used as a dietary source of at least one of a) protein and/or an amino acid; b) a lipid; c) dietary fiber; d) choline and/or a vitamin; and e) a mineral, in at least one of a food product, a beverage, a pet food product and a feed product. The term “dietary source of” as used herein, refers to the consumption of a product comprising a specific dietary component.

The composition comprising biomass of a thermophilic fungus for a use according to the invention preferably is obtained or obtainable in one of the following processes.

In one embodiment, the composition comprising biomass of a thermophilic fungus is a cake obtained or obtainable in a process comprising the steps of a) growing a strain of a thermophilic fungus in submerged culture in a medium, b) recovery of the fungal biomass from the medium by at least one of sieving, filtration and decantation to produce a biomass cake, whereby preferably the dry matter concentration of the sieved, filtered or decanted biomass cake is at least 12% (w/v), and c) optionally, further drying the biomass cakes by pressing residual water out to obtain a biomass cake with a dry matter concentration of at least 20%.

In another embodiment, the composition comprising biomass of a thermophilic fungus is a dried powder obtained or obtainable in a process as defined above, further comprising step d) wherein the biomass cake obtained in b) or c) above is milled and further dried to a biomass powder by warm air, by freeze drying, preferably under vacuum, or by flash drying, preferably to a water content of no more than 7% (w/w). More preferably, the water content is no more than 5% (w/w).

Processes, conditions and media for growing thermophilic fungus in submerged culture in a medium are described in detail in WO 2018/029353 or US2019174809, which is incorporated by reference herein. Preferably the process comprises the step of: a) growing a thermophilic fungus in a medium containing a fermentable carbon-rich feedstock, a nitrogen source and further components necessary for growth of the fungus. Preferably, in step a) the fungus is grown in submerged culture. Preferably, in step a) the fungus is grown under non-sterile conditions. Preferably, in step a) the fungus is grown at a temperature of 30, 31, 32, 33, 34, 35, 36, 37, 38, 39, 40, 41, 42, 43, 44, 45, 46, 47, 48, 49, 50, 51, 52, 53, 54 or 55° C. or more. Preferably, in step a) the fungus is grown at a pH less than 5.0, 4.9, 4.8, 4.7, 4.6, 4.5, 4.4, 4.3, 4.2, 4.1, 4.0, 3.9, 3.8, 3.7, 3.6, 3.5, 3.4, 3.3, 3.2, 3.1, 3.0, 2.9, 2.8, 2.7, 2.6 or 2.5.

In one embodiment of a process of the invention, the strain of a thermophilic fungus is preferably grown or cultured in a chemically defined medium. The term “chemically defined” is understood to be used for fermentation media which are essentially composed of chemically defined constituents, i.e. the chemical composition of essentially all the chemicals used in the media is known.

Thus in one embodiment, the strain of the thermophilic fungus is cultured in a chemically defined medium, consisting of a carbon source, a nitrogen source and further components necessary for growth of the fungus.

The carbon source preferably comprises or consists of at least one of carbohydrate and an organic acid. Preferably, the carbohydrate comprises a source of at least one of glucose, fructose, galactose, xylose, arabinose, rhamnose, fucose, galactose and mannose, of which glucose and fructose are preferred, and glucose is most preferred. Suitable carbohydrate carbon sources comprising a source of e.g. glucose and/or fructose include e.g. maltose, isomaltose, maltodextrins, starch, glucose syrups (e.g. corn syrups such as HCFS), inverted (cane or sugar beet) sucrose, a crude starch, a starch liquefact (e.g. by liquefying using alpha amylase such as Liquozyme (Novozymes) or Veretase (BASF), inulin, raffinose, melibiose and stachyose. Organic acids that can be comprised in the carbon source include lactic acid, acetic acid, galacturonic acid, glucuronic acid.

The nitrogen source in the chemically defined medium to be used in the processes of the invention preferably comprises or consists of at least one of urea, ammonia, nitrate, ammonium salts such as ammonium sulphate, ammonium phosphate and ammonium nitrate, and amino acids such as glutamate and lysine. More preferably, a nitrogen source is selected from the group consisting of ammonia, ammonium sulphate and ammonium phosphate. Most preferably, the nitrogen source is ammonia.

The further components necessary for growth of the fungus include e.g. catalytic elements which are constituents of enzymes or enzyme cofactors. These elements include e.g. magnesium, iron, copper, calcium, manganese, zinc, cobalt, molybdenum, selenium and borium. In addition to the aforementioned structural and catalytic elements, cations such as potassium and/or sodium preferably are present to function as a counter ion and for control of intracellular pH and osmolarity. Suitable mineral compositions for the chemically defined medium of the invention are described in US20140342396A1, which is incorporated by reference herein.

Compounds which may optionally be included in the (chemically defined) media for growing a fungus are chelating agents, such as citric acid, and buffering agents such as mono- and dipotassium phosphate, calcium carbonate, and the like, and vitamins. Buffering agents are preferably only added when dealing with processes without an external pH control. Vitamins refer to a group of structurally unrelated organic compounds which may be necessary for the normal metabolism of thermophilic fungi. Fungi are known to vary widely in their ability or inability to synthesize the vitamins they require. A vitamin only needs to be added to the fermentation medium of a fungal strain incapable of synthesizing said vitamin. Typically, chemically defined fermentation media for lower fungi, e.g. Mucorales, may require supplementation with one or more vitamin(s). Higher fungi often have no vitamin requirement. Vitamins are selected from the group of thiamin, riboflavin, pyridoxal, nicotinic acid or nicotinamide, pantothenic acid, cyanocobalamin, folic acid, biotin, lipoic acid, purines, pyrimidines, inositol, choline and hemins. In a preferred embodiment, however, the thermophilic fungi that is grown in the process of the invention is a strain that does not require the presence of any vitamins in the chemically defined medium. Indeed, the inventors have found that species of the genus Rhizomucor, e.g. the strains Rhizomucor pusillus CBS 143028, Rhizomucor miehei CBS 143029 and Rhizopus sp. CBS 143160, do not require any vitamins, even when grown on a mineral medium.

In a further preferred embodiment, the fungus is grown in step a) in a medium as defined herein in the presence of a defoaming agent. Defoaming agents are generally well-known in the art (see e.g. https://en.wikipedia.org/wiki/Defoamer). A defoaming agent is a chemical additive that reduces and hinders the formation of foam in industrial process liquids, such as fermentation broths. While strictly speaking, defoamers eliminate existing foam and anti-foamers prevent the formation of further foam, the terms defoaming agent, anti-foam agent and defoamer are herein used interchangeably. A defoaming agent that is suitable for use in fermentation processes of the invention preferably is at least one of an oil-based defoamer, a polyalkylene glycol-based defoamer and a silicon-based defoamer. Examples thereof include respectively vegetable or mineral oils and animal fat, polypropylene glycol (PPG) or polyethylene glycol (PEG) and Antifoam C100K (Basildon Chem. Comp. Ltd, Abingdon, Oxford, UK). The defoaming agent preferably is a food-grade defoaming agent. A preferred food-grade defoaming agent is a clean-label defoaming agent. Preferred defoaming agent for use in a process of the invention comprises or consist of a vegetable oil, preferably an edible vegetable oil. A preferred (edible) vegetable oil for use as defoaming agent in a process of the invention is an oil is selected from the group consisting of canola (rapeseed) oil, coconut oil, corn oil, cottonseed oil, olive oil, palm oil, palm kernel oil, linseed oil, peanut oil, safflower oil, soya bean oil, sunflower oil and high-oleic sunflower oil.

In one embodiment, the thermophilic fungus that is grown to produce the composition comprising biomass of a thermophilic fungus according to the invention, preferably is filamentous fungus. A preferred thermophilic fungus for use in the invention is a strain of a fungal genus selected from the group consisting of Rasamsonia, Talaromyces, Penicillium, Acremonium, Humicola, Paecilomyces, Chaetomium, Rhizomucor, Rhizopus, Thermomyces, Myceliophthora, Thermoascus, Thielavia, Mucor, Stibella, Melanocarpus, Malbranchea, Dactylomyces, Canariomyces, Scytalidium, Myriococcum, Corynascus, and Coonemeria. More preferably, the thermophilic fungus is a strain of a fungal species selected from the group consisting of Rasamsonia composticola, Talaromyces emersonii, Rhizomucor miehei, Rhizomucor pusillus, Thermomucor indica-seudaticae, Thielava terricola, Thielava terrestris, Thermoascus thermophilus of which the strains Rasamsonia composticola CBS 141695 (deposited on 29 Jul. 2016), Thermomucor indicae-seudaticae CBS143027 (deposited on 21 Jul. 2017), Rhizomucor miehei CBS143029 (deposited on 21 Jul. 2017), Rhizomucor pusillus CBS 143028 (deposited on 21 Jul. 2017), Thermascus thermophilus CBS 528.71 and Thielavia terrestris CBS 546.86 are preferred.

In a preferred embodiment, the thermophilic fungus is a strain of the Class Zygomycete, of which the Family Mucoraceae is preferred. More preferably the thermophilic fungus is a strain of a genus selected from the genera Mucor, Rhizomucor and Rhizopus, of which the genus Rhizomucor is preferred. Most preferably the thermophilic fungus is a strain of a species selected from the species R. endophyticus, R. miehei, R. pakistanicus, R. tauricus, R. variabilis and R. pusillus, of which the species Rhizomucor pusillus is preferred. Preferred strains of the aforementioned thermophilic fungi for use in the invention include the following strains that were deposited under the regulations of the Budapest Treaty at the Westerdijk Fungal Biodiversity Institute, Uppsalalaan 8, 3584 CT Utrecht, The Netherlands (formerly referred to as Centraalbureau voor Schimmelcultures, CBS) Rhizomucor pusillus CBS 143028, Rhizomucor miehei CBS 143029 and Rhizopus sp. CBS 143160 (deposited on 11 Aug. 2017), of which Rhizomucor pusillus CBS 143028 is most preferred.

In one embodiment, the process of the invention is a batch process, more preferably at least step a) of the process is carried out as a batch process. In a preferred embodiment however, the process of the invention, or preferably at least step a) of the process, is carried out as is a fed-batch process, a repeated fed-batch process (wherein repeatedly a part of the fermentation broth is harvested) or a continuous process. In one embodiment, the process in step a) is a carbon-limited process, wherein preferably, the carbon source is fed at a growth-limiting rate by feeding continuously or by intermittent feeding.

In one embodiment, subsequent to the fermentation the fungal biomass can be pasteurized, preferably at a temperature of at least 60° C., e.g. as described in co-pending application with no. EP20161554.9. Preferably, the biomass is pasteurized for at most 45 minutes at a temperature of at least 70° C. In preferred embodiments, the pasteurization is performed in an in-line heating unit that preferably comprises a pipe heater, a heating block, or a steam infusion element, more preferably a steam infusion element, and wherein the in-line heating unit optionally comprises a mixing element such as a static mixer. Preferably, the pasteurization is performed for at most 5 minutes, preferably from about 0.5 to about 3 minutes, more preferably from about 1 to 2 minutes. Preferably, pasteurization is performed at a temperature of at least 74° C., preferably at least 80° C., more preferably at least 86° C. Preferably, the germ count of the pasteurized biomass has a log₁₀ reduction of at least 7, preferably of at least 11, more preferably of at least 12, as compared to the provided biomass prior to pasteurization. In preferred embodiments, the biomass flows through an in-line heating unit where it has a residence time of about 1 to 2 minutes at a temperature of about 86° C., wherein the pH of the biomass is preferably at most 4.5, more preferably at most 3.5.

In one embodiment, an antioxidant is added to the biomass. Preferably, the antioxidant is added before pasteurization of the biomass, e.g. as described in co-pending application with no. EP20161606.7. Preferably the antioxidant is at least one of a free radical scavenger, such as carnosol; carnosic acid; rosemary extract; a flavan-3-ol such as epicatechin, epigallocatechin, epigallocatechin gallate (EGCG), epicatechin gallate; a flavonoid such as kaempferol, quercetin, or myricetin; green tea extract; butylated antioxidants such as butylated hydroxytoluene (BHT), butylated hydroxyanisole, or tert-butylhydroquinone (TBHQ); gallic acid; a gallate ester such as propyl gallate; carvone; a caffeate ester such as methyl caffeate, ethyl caffeate, caffeic acid phenethyl ester (CAPE), or rosmarinic acid; spearmint extract; a vitamin E such as a tocopherol or a tocotrienol; a vitamin A such as retinol, retinoic acid, or retinal; a provitamin A such as a carotenoid, p-carotene, lutein, zeaxanthin, or echinenone; a quinolone-based antioxidant such as ethoxyquin; or seaweed extract; or an oxygen reducer, such as ascorbic acid or acerola extract; or a chelator, such as citric acid or EDTA. Preferably the obtained biomass composition has a TOTOX value of under 50, preferably under 35, more preferably under 20, and wherein the TOTOX value preferably remains under 50, more preferably under 40, for at least 6 weeks.

Next, the fungal biomass is preferably separated from the fermentation medium. Thus, in one embodiment, the process for preparing the composition comprising biomass of a thermophilic fungus preferably comprises a further step of b) recovery of fungal biomass (grown in step a)) from the medium, preferably, by at least one of sieving, filtration and decantation. More preferably, the biomass is recovered from the medium by at least one of rotating drum filtration, a filter press, a belt filter, a decanter centrifuge and sieving. Preferably biomass is recovered by sieving on a sieve or a screen, preferably with 100, 200, 300, 400 or 500 μm, or 0.6, 0.7, 0.8, 0.9, 1.0, 1.5, or 2 mm diameter of pores. The biomass can be recovered by at least two, three or four consecutive rounds of sieving on a sieve or screen whereby a smaller diameter of pores is applied in each subsequent round of sieving. E.g. a first round of sieving using 2 mm pore diameter, followed by subsequent rounds of 1, 0.5 and/or 0.1 mm. Optionally, dry matter concentration of the sieved, filtered or decanted biomass (cake) is further increased by further removal of water, i.e. drying. The biomass cake can e.g. be further dried by pressing (more of) the residual water out using e.g. compressed air using a pneumapress and/or mechanical pressing, using e.g. a belt press or a screw press. The biomass cake thus obtained preferably has a dry matter concentration of at least 12, 15, 20, 25, 30, 35, 40, 45 or 50% (w/w).

In another embodiment, pressing the biomass to a cake, optionally the cake can be milled or extruded e.g. to enable drying, preferably air drying. Preferably, the particle size of the pressed mycelial biomass cake is reduced by physical means to enable (more efficient) drying of the pressed cake. This can optionally done by extrusion of the mycelial cake through holes with a diameter of 0.6, 0.7, 0.8, 0.9, 1.0, 1.2, 1.4, 1.6, 1.8 or 2 mm, using extruders that are known in the art per se. Alternatively, the particle size of the cake can be reduced by a combination of milling and sieving. As a milling step any type of mill known in the art per se can be used, such as e.g. a knife mill or a hammer mill, etc. To obtain homogeneous particle size of the milled pressed cake, the larger particles still present after milling can be removed before drying by sieving with a pore diameter size in the sieve of 0.5, 1.0, 1.2, 1.4, 1.6, 1.8, 2.0, 2.5 or 3 mm. The resulting milled cake would have preferably a particle size between 1-3 mm before drying. Drying of the extruded or milled cake is preferably done at temperatures of 30-70° C. The hot air can then dry the cake in a gentle and cost effective way in a belt dryer or fluid bed dryer. Steam drying at high temperatures (e.g. >80° C.) is not preferably avoided as it can negatively influence digestibility of the proteins by denaturing and baking and even chemical decomposition of the amino acids by Maillard reactions. Alternatively, the extruded or milled cake is dried under vacuum in freeze drying process or by flash drying. The biomass in the form of dried powder thus obtained preferably has a water content of no more than 5, 4, 3, 2 or 1% (w/w).

The cake form of the thermophilic fungal biomass may be frozen and stored at −18° C., while the powder form may be stored at room temperature.

Protein and Amino Acids

In one embodiment, the composition comprising the biomass of a thermophilic fungus of the invention is used as a (dietary) source of protein. Preferably the protein comprises an amino acid selected from the group consisting of aspartic, acid, asparagine, threonine, serine, glutamic acid, glutamine, proline, glycine, alanine, citrulline, valine, isoleucine, leucine, tyrosine, phenylalanine, lysine, histidine, arginine, cysteine, methionine and tryptophan.

In one embodiment, the composition comprising the biomass of a thermophilic fungus of the invention is used as a (dietary) source of an amino acid. In a preferred embodiment, the amino acid is an amino acid selected from the group consisting of aspartic, acid, asparagine, threonine, serine, glutamic acid, glutamine, proline, glycine, alanine, citrulline, valine, isoleucine, leucine, tyrosine, phenylalanine, lysine, histidine, arginine, cysteine, methionine and tryptophan.

Proteins represent the main source of nitrogen and indispensable amino acids in the human diet. Both are fundamental for tissue growth and maintenance [3]. The main protein source in the human diet are of animal origin (meat, fish, eggs, dairy products) or plant-based, such as leguminous vegetables, nuts, grain-based products. However, proteins of animal origin are within the most high-quality ones in terms of amino acid composition. All amino acids are important in human nutrition, but some cannot be produced de novo by humans and, therefore, can be introduced only through the diet. These amino acids are defined as essential amino acids. The amino acids which are essential for humans are: threonine, valine, isoleucine, leucine, phenylalanine, lysine, histidine, methionine and tryptophan [3].

In one embodiment, the composition comprising the biomass of a thermophilic fungus of the invention is used as a (dietary) source of protein comprising essential amino acids. Preferably, the essential amino acid is selected from the group consisting of threonine, valine, isoleucine, leucine, phenylalanine, lysine, histidine, methionine and tryptophan.

In one embodiment, the composition comprising the biomass of a thermophilic fungus of the invention is used as a (dietary) source of an essential amino acid. Preferably, the essential amino acid is selected from the group consisting of threonine, valine, isoleucine, leucine, phenylalanine, lysine, histidine, methionine and tryptophan. More preferably, the composition comprising the biomass of a thermophilic fungus of the invention is used as a (dietary) source of all essential amino acids.

Citrulline malate is commercially available and widely used as product for sporting people to improve exercise performance and muscle recovery. Supplementation with L-citrulline has shown to improve vascular function and, therefore, improve exercise performance and reduce muscle fatigue after exercise [4]. Besides its high protein content and the presence of all essential amino acids, the fungal biomass of the invention represents a good ingredient for food for sporting people thanks to its high citrulline content. In one embodiment, the composition comprising the thermophilic fungus derived biomass is used as a (dietary) source of citrulline. Preferably, the composition is used in food a food supplement or a beverage for sporting people.

The high protein content of fungal biomass of the invention makes it a good alternative to animal proteins in vegetarian and vegan food products. In one embodiment therefore, the thermophilic fungus derived biomass is used as a (dietary) source of at least one of protein, amino acids and essential amino acids as defined herein, in a vegetarian or a vegan food product.

### Fiber

In one embodiment, the composition comprising the biomass of a thermophilic fungus of the invention is used as a (dietary) source of dietary fiber.

Dietary fibers are defined as non-digestible carbohydrates which play an important role in the human bowel function. The Adequate Intake (AI) of dietary fibers for adults (both genders) for normal laxation has been set as 25 g/day, according to the EFSA DRV. A dietary fiber intake higher than 25 g/day in adults has shown to reduce risk of coronary diseases, of type 2 diabetes and to help weight maintenance. Moreover, a high daily intake of dietary fibers has shown to be related to a lower risk of colorectal cancer [1]. Dietary fibers are fermented by the bacteria inhabiting the large intestine, having an important role on the microbial composition of the gut microbiota. Microbial fermentation of dietary fibers can provide many other micronutrients which can be absorbed by the human gut, such as vitamins and Short Chain Fatty Acids (SCFAs) [2]. The main source of dietary fiber in the human diet are whole grain cereals, vegetables, fruits and potatoes.

The biomass of a thermophilic fungus of the invention has a relatively high content of dietary fiber (10.6 g dietary fiber/100 g or 37% of dry matter). The fungal biomass of the invention is therefore an excellent source of dietary fiber for use in a food product, a beverage, a pet food product or a feed product.

Specifically, the high dietary fiber content, makes it possible to add dietary fibers to foods which are normally poor in fibers. One example thereof is a meat replacer made with fungal biomass of the invention: the proteins of thermophilic fungus derived biomass can replace animal proteins contained in meat products and, at the same time, fungal biomass enriches the meat replacer with dietary fibers which are basically absent from meat products.

In one embodiment, the thermophilic fungus derived biomass of the invention is therefore used as a source of dietary fiber in a food product that is a meat replacer or a hybrid meat product. Due to its texture, the cake form of the thermophilic fungus derived biomass is particularly suitable as ingredient for meat replacers and hybrid meat products.

Similarly, dietary fiber and proteins are essential macronutrients in pet food as well. The main companion animals, dogs and cats, have different requirements for dietary fiber and proteins. Moreover, the essential amino acids needed in the diet of a pet differs from those needed in the human diet. Nowadays protein sources for pet food are represented by ingredients of animal origin (poultry, beef, pork, fish, eggs) or plant-based ingredients such as corn, rice, peas and soybeans. In addition, dietary fibers are important for stool quality, weight management and satiety of pets, as well as of human beings [5].

In one embodiment, therefore the thermophilic fungus derived biomass of the invention is used as a source of dietary fiber to enrich the fiber content of a food product. The food product to be enriched with dietary fiber can be a food product selected from: i) a meat replacer; ii) a hybrid food product containing meat and non-meat ingredients; iii) a carbohydrate-rich food product; iv) a bakery product made with refined flours and v) a pet food. More specifically, the food product to be enriched with dietary fiber can be a food product selected from: pizza and pizza-like dishes, savory pies and tarts, ready to eat soups, pasta and similar products, pre-mixes (dry) for baked products, biscuits, cakes, pancakes, bread and rolls, pizza base (cooked), gluten free bread, porridge (dry/ready to eat), cereal bars, cereal flakes and similar, muesli and mixed breakfast cereals, food for sporting people, food for weight reduction, dairy ice creams and similar, fermented milk products, chocolate and chocolate products.

In one embodiment, therefore the thermophilic fungus derived biomass of the invention is used as a source of dietary fiber in a human or pet food product to provide satiety, preferably to a human or pet in need of weight management or weight loss.

### Micronutrients

The thermophilic fungus derived biomass of the invention has a high content of choline (Table 8). While choline can be synthesized de novo by the human body, it still represents a fundamental component of human diet, since the amount produced de novo is not always enough for adequate intake, which is 400 mg/day for adults (both genders) [9]. In contrast, choline is an essential vitamin for dogs and cats. For adult cats the minimum required nutrient level of choline is 60 mg/kg metabolic body weight (BW), while for adult dogs 45 mg/kg metabolic BW [11]. The thermophilic fungus derived biomass of the invention therefore represents a good choline source for human and animal nutrition and can e.g. be used as source of choline in vegan food products, in alternative to animal-based products such as eggs, dairy and meat which are generally good sources of choline.

In one embodiment, the thermophilic fungus derived biomass of the invention is used as a (dietary) source of choline in a vegan or vegetarian food product, or in a pet food, preferably a cat or dog food.

Besides choline, the thermophilic fungus derived biomass of the invention contains other vitamins which are essential for humans and/or animals, such as retinol (vitamin A), vitamin E, riboflavin (vitamin B2), pyridoxine (vitamin B6) and folate (vitamin B9/B111) (see Table 8).

Vitamin E is known to have antioxidant activity [13]. Vitamin B2 is also known as riboflavin and is involved in a variety of reaction in the human body [14], whereas vitamin B6 plays an important role on different metabolism pathways such as amino acid metabolism, one-carbon metabolism, glycogenolysis and gluconeogenesis and haem synthesis [15].

In one embodiment, therefore, the thermophilic fungus derived biomass of the invention is used as a (dietary) source of at least one of retinol (vitamin A), vitamin E, riboflavin (vitamin B2), pyridoxine (vitamin B6) and folate.

Vitamin A plays an important role in the mechanism of eye phototransduction in both humans and animals [12]. Vitamin A is a particularly essential vitamin for cats [11]. Therefore, in a preferred embodiment, the thermophilic fungus derived biomass of the invention is used as a (dietary) source of retinol in cat food.

### Minerals

The thermophilic fungus derived biomass of the invention has a high content of different minerals (Table 10). This is due to the minerals which are added during the fermentation process and are needed for the growth of the fungus. This means that the mineral composition of the Rhizomucor pusillus biomass can be modified and/or standardized based on its application in different food or feed products.

In one embodiment, the composition comprising the biomass of a thermophilic fungus of the invention is used as a (dietary) source of a mineral selected from the group consisting of: calcium, magnesium, phosphorus, potassium, zinc, iron, copper and manganese.

The iron (Fe) content in the fungal biomass of the invention was particularly high and represented a limiting factor for the intake assessment according to the EFSA DRV. The iron dosage used in the fermentation of the fungal biomass of the invention even had to be reduced to reach a final concentration of 14 mg/kg (Table 10).

The thermophilic fungus derived biomass of the invention can thus be considered as a valuable source of iron in alternative to other plant-based products which meat replacers are made of, such as soya (see Table 11). Soya products are usually introduced in vegetarian or vegan diets thanks to its high iron content. However, soya may not be introduced in everyone's diet in case of allergy. Soya is indeed considered one of the main food allergens. The thermophilic fungus derived biomass of the invention can be used to replace soya as iron source in vegetarian and vegan diets. Therefore, in one embodiment, the biomass of the thermophilic fungus is used as a source of iron. In a preferred embodiment, the biomass of the thermophilic fungus is used to replace an iron source. In a more preferred embodiment, the biomass of the thermophilic fungus is used to replace soya as a source of iron, more preferably, the biomass of the thermophilic fungus is used to replace soya as source of iron in a meat replacer.

### Lipid

The thermophilic fungus derived biomass of the invention contains about 8% (w/w) fat on a dry matter basis, of which about 16-22% (w/w) consists of saturated fatty acids, about 50-56% (w/w) consists of mono-unsaturated fatty acids (mostly oleic acid) and about 27-28% (w/w) consists of poly-unsaturated fatty acids (mostly linoleic acid). In one embodiment, therefore, the biomass thermophilic fungus is used as a source of at least one of mono-unsaturated fatty acids and poly-unsaturated fatty acids. More preferably, the biomass thermophilic fungus is used as a source of at least one of oleic acid and linoleic acid.

### Food Products, Beverages, Pet Foods and Animal Feed

In a further aspect, the invention relates to a food product, a beverage, a pet food product and a feed product comprising the thermophilic fungus derived biomass of the invention.

The biomass of the thermophilic fungus of the invention in either the cake or powder as described herein, can be used as ingredients in different food categories, with different use levels. The maximum use levels of the thermophilic fungus of the invention in different food categories (Table 1) have been set upon an intake assessment based on the European Food Safety Authority (EFSA) Dietary Reference Values (DRV) for macro- and micronutrients contained in the thermophilic fungus of the invention and based on the background diet of different European population groups.

In one embodiment, the thermophilic fungus derived biomass is incorporated in at least one of a food product and a beverage at level less than or equal to the maximum use level of a food for the thermophilic fungus derived biomass as based on the European Food Safety Authority (EFSA) Dietary Reference Values (DRV).

Therefore, the thermophilic fungus derived biomass is used for incorporating into a food product, a beverage, a pet food product and a feed product at a maximum level of 70, 65, 60, 55, 52, 50, 45, 42, 40, 35, 30, 25 or 20% (w/w), in either cake or powder form. Preferably, a food product, a beverage, a pet food product and a feed product comprise at least 1, 2, 5, 10 or 15% (w/w) of the thermophilic fungus derived biomass, in either cake or powder form.

In one embodiment, the thermophilic fungus derived biomass is used as an ingredient for a meat replacer, wherein preferably the meat replacer comprises no more than 42% (w/w) of the biomass of the thermophilic fungus in cake form, or no more than 14% (w/w) of the biomass of the thermophilic fungus in powder form. Thus, in one embodiment, the invention pertains to a food product that is a meat replacer comprising no more than 42% (w/w) of the biomass of the thermophilic fungus in cake form, or no more than 13% (w/w) of the biomass of the thermophilic fungus in powder form. The meat replacer preferably comprises at least 1, 2, 5, 10 or 15% (w/w) of the thermophilic fungus derived biomass in cake form or at least 0.5, 1, 2 or 5% (w/w) in powder form.

In one embodiment, the thermophilic fungus derived biomass is used as an ingredient for a hybrid meat product, in which part of the meat content is replaced by other protein sources, usually of vegetal origin. Preferably the hybrid meat product comprises no more than 52% (w/w) of the biomass of the thermophilic fungus in cake form, or no more than 16% (w/w) of the biomass of the thermophilic fungus in powder form. Thus, in one embodiment, the invention pertains to a food product that is a hybrid meat product comprising no more than 52% (w/w) of the biomass of the thermophilic fungus in cake form, or no more than 16% (w/w) of the biomass of the thermophilic fungus in powder form. The hybrid meat product preferably comprises at least 1, 2, 5, 10 or 15% (w/w) of the thermophilic fungus derived biomass in cake form or at least 0.3, 0.6, 1.5, 3% or 4.5% (w/w) in powder form.

In one embodiment, the thermophilic fungus derived biomass is used as an ingredient in the bakery industry, e.g. as a substitute of or in addition to grain (or legume) flours. Such grain and/or legume flours include but are not limited to grain flours (e.g. wheat, spelt, barley, rye, Khorasan, emmer, einkorn, triticale (containing gluten)), grain flours (e.g. oats, corn, millet, sorghum, quinoa, rice (gluten free)), legume flours (e.g. chickpea flour, soy flour) and flours from tubers (e.g. potato flour, tapioca flour). An example bakery product is bread, however the thermophilic fungus derived biomass can also be used as ingredient for other cereal-based food products such as, but not limited to, pasta and similar, pre-mixes (dry) for baked products, biscuits, cakes, pancakes, porridge (dry/ready to eat), cereal bars, cereal flakes, muesli, bread, gluten free bread and pizza base (cooked). Preferably the bakery product comprises no more than 10% (w/w) of the biomass of the thermophilic fungus in powder form, as a substitute of or in addition to grain (or legume) flours as disclosed herein. Thus, in one embodiment, the invention pertains to a bakery product comprising 10% (w/w) of the biomass of the thermophilic fungus, as a substitute of or in addition to grain (or legume) flours as disclosed herein. The bakery product comprising preferably comprises at least 1, 2, 5 or 10 (w/w) of the thermophilic fungus derived biomass in powder form, as a substitute of or in addition to grain (or legume) flours as disclosed herein.

Preferably the cereal-based food product comprises no more than 33% (w/w) of the biomass of the thermophilic fungus in cake form, or no more than 10% (w/w) of the biomass of the thermophilic fungus in powder form. Thus, in one embodiment, the invention pertains to a food product that is a cereal-based food product comprising no more than 33% (w/w) of the biomass of the thermophilic fungus in cake form, or no more than 10% (w/w) of the biomass of the thermophilic fungus in powder form. The cereal-based food product preferably comprises at least 1, 2, 5, 10 or 15% (w/w) of the thermophilic fungus derived biomass in cake form or at least 0.3, 0.6, 1.5, 3 or 4.5% (w/w) in powder form.

In one embodiment, the thermophilic fungus derived biomass is used as an ingredient in ready to eat meals, e.g. savory pies, pizza-like dishes, savory tarts, soups and porridge. Preferably, the ready to eat meal food product comprises no more than 16% (w/w) of the biomass of the thermophilic fungus in cake form, or no more than 5.3% (w/w) of the biomass of the thermophilic fungus in powder form. Thus, in one embodiment, the invention pertains to a food product that is a ready to eat meal food product food product comprising no more than 16% (w/w) of the biomass of the thermophilic fungus in cake form, or no more than 15.3% (w/w) of the biomass of the thermophilic fungus in powder form. The ready to eat meal food product preferably comprises at least 1, 2, 5 or 10% (w/w) of the thermophilic fungus derived biomass in cake form or at least 0.5, 1 or 2% (w/w) in powder form.

In one embodiment, the thermophilic fungus derived biomass is used as an ingredient in soups, preferably in a ready to eat soup comprising one or more of water, stock vegetables, meat, fruit, pasta, seasoning, aromas, flavorings and stabilisators. Preferably, the soup comprises no more than 25% (w/w) of the biomass of the thermophilic fungus in cake form, or no more than 7.5% (w/w) of the biomass of the thermophilic fungus in powder form. Thus, in one embodiment, the invention pertains to a food product that is a soup, preferably a ready to eat soup, comprising no more than 25% (w/w) of the biomass of the thermophilic fungus in cake form, or no more than 7.5% (w/w) of the biomass of the thermophilic fungus in powder form. The soup product preferably comprises at least 1, 2, 5, 10 or 15% (w/w) of the thermophilic fungus derived biomass in cake form or at least 0.5, 1, 2 or 5% (w/w) in powder form.

In one embodiment, the thermophilic fungus derived biomass is used as an ingredient in a food product for sporting people. The food product for sporting people can e.g. be a protein shake or a protein bar comprising one or more of a protein source (e.g. whey protein, soy protein, pea protein), flavors, stabilizers, sugars, colorings, eventually minerals and vitamins. Preferably, the food product for sporting people comprises no more than 70% (w/w) of the biomass of the thermophilic fungus in cake or in powder form. Thus, in one embodiment, the invention pertains to a food product for sporting people, preferably a protein shake or a protein bar, comprising no more than no more than 70% (w/w) of the biomass of the thermophilic fungus in cake or in powder form. The food product for sporting people preferably comprises at least 1, 2, 5, 10, 20 or 40% (w/w) of the thermophilic fungus derived biomass in either cake form or powder form.

TABLE 1
Selected food categories and maximum use levels of thermophilic
fungus derived biomass in each food category.

| | Maximum use | Maximum use |
|---|---|---|
| Food category according to EFSA | level (g/100 g), | level (g/100 g), |
| classification (FoodEx2 name) | powder product | cake product |
| Pizza and pizza-like dishes | — | 10 |
| Savory pies and tarts | — | 16 |
| Soups ready to eat | 7.5 | — |
| Pasta and similar products | 10 | — |
| Pre-mixes (dry) for baked products | 10 | — |
| Biscuits, sweet, plain | 10 | — |
| Plain cakes | 10 | — |
| Pancakes | 10 | — |
| Porridge (dry for, to be diluted) | 8 | — |
| Porridge (ready to eat) | 8 | — |
| Cereal bars | 10 | — |
| Cereal flakes and similar | 10 | — |
| Muesli and similar mixed breakfast | 10 | — |
| cereals | | |
| Bread and rolls with special ingredients | 10 | — |
| added | | |
| Pizza base, cooked | 10 | — |
| Gluten free bread | 10 | — |
| Meat imitates | — | 42 |
| Food for sporting people | 70 | — |
| Food for weight reduction | 70 | — |
| Hybrid meat products (meat balls, | — | 52 |
| sausages, minced meat) | | |
| Dairy ice creams and similar | 10 | — |
| Fermented milk products | 4 | — |
| Chocolate and chocolate products | 1 | — |

Besides its use in food products, the biomass of the thermophilic fungus of the invention is a valuable alternative ingredient for feed products such as pet food, thanks to its structure (both cake and powder) and nutritional value. Thus, in one embodiment, the thermophilic fungus derived biomass is used as an ingredient in pet food. As used herein, the term “pet” mean a domestic or domesticated animal including, but not limited to, domestic dogs, cats, ferrets, rabbits, pigs, and the like. A pet food is herein understood to mean a composition intended for oral consumption to meet one or more nutritional needs of a pet. The pet food may be selected from a treat, chew, biscuit, gravy, supplement, topper, and combinations thereof. The pet food may or may not be nutritionally balanced and complete. The biomass of the thermophilic fungus represents a good dietary fiber, protein and essential amino acid source to be used in pet food. The amount of biomass of the thermophilic fungus in pet food may be defined based on different pets' nutritional needs. Some pets may need more attention to their diet due to weight management or weight loss. In this case, the biomass of the thermophilic fungus may provide satiety to pets thanks to its high dietary fiber content. Besides this, the biomass of the thermophilic fungus can be a protein source alternative to standard animal or plant-based pet food ingredients. Thus, in one embodiment, the biomass of the thermophilic fungus is used as a source of protein, amino acids and essential amino acids in a pet food, preferably as alternative to standard animal or plant-based sources of protein, amino acids in pet food more preferably as sole source of protein and/or amino acids.

### General Definitions

In this document and in its claims, the verb “to comprise” and its conjugations is used in its non-limiting sense to mean that items following the word are included, but items not specifically mentioned are not excluded. In addition, reference to an element by the indefinite article “a” or “an” does not exclude the possibility that more than one of the element is present, unless the context clearly requires that there be one and only one of the elements. The indefinite article “a” or “an” thus usually means “at least one”. The word “about” or “approximately” when used in association with a numerical value (e.g. about 10) preferably means that the value may be the given value more or less 5% of the value. As used herein, “subject” means any animal, preferably a mammal, most preferably a human. In preferred embodiments a subject is non-human.

In the context of this invention, a decrease or increase of a parameter to be assessed means a change of at least 5% of the value corresponding to that parameter. More preferably, a decrease or increase of the value means a change of at least 10%, even more preferably at least 20%, at least 30%, at least 40%, at least 50%, at least 70%, at least 90%, or 100%. In this latter case, it can be the case that there is no longer a detectable value associated with the parameter.

Throughout this document, when percentages are used for expressing amounts of a substance in a mixture, weight percentages are intended, unless stated otherwise or explicitly plain from context.

The present invention has been described above with reference to a number of exemplary embodiments. Modifications and alternative implementations of some parts or elements are possible, and features from embodiments can be combined where possible. All citations of literature and patent documents are hereby incorporated by reference.

### EXAMPLES

### Example 1: Production of Rhizomucor pusillus Biomass in Cake or Powder Form

For preculture Rhizomucor pusillus strain CBS 143028 was inoculated in 200 ml of a defined mineral medium at pH 5.5 containing KCl 0.17 g/L, KH₂PO₄ 1.3 g/L, Na₂HPO₄ 0.4 g/L, citric acid 0.5 gr/L, MgSO₄·7aq 0.7 gr/L, FeSO₄·7aq 0.03 gr/L, CaCl₂·2aq 0.035 gr/L, ZnSO₄·7aq 0.04 gr/L, MnCl₂·4aq 0.004, CuSO₄·5aq 0.0005 gr/L, CoCl₂·6aq 0.0005 gr/L, Na2B₄O₇·10aq 0.003 gr/L, KI 0.0003 gr/L, Na₂MoO₄·2aq 0.0005 gr/L, 11 g Dextrose per L; 4 g (NH₄)₂SO₄ per L; and 7.5 g tartaric acid per L. The preculture was incubated for 24 hours at 46° C., in a 1 L Erlenmeyer flask with air permeable stop with baffles, in an orbital shaker at 200 rpm. The preculture was then used to inoculate a fermenter containing the defined mineral medium as described above at a pH of 3.5 and comprising 77 g Dextrose per L as C-source; 1.4 g (NH₄)₂SO₄ per L as N-source and supplemented with NH₃ as titrant. The fungus was grown in the fermenter in fed batch mode at a doubling time of 12 hours. Olive oil was continuously being fed to maintain a concentration of 50 ppm.

Fermentation broths, having reached a dry matter content ranging from 2 to 5 weight percent, were concentrated using a vibrating sieve to achieve a minimum of 10% (w/w) dry matter. The biomass is than mixed with anti-oxidant and pasteurized.

Next the sieved biomass was compressed with a hydraulic press to obtain the Rhizomucor pusillus biomass as a cake with a dry matter content of about 29% (w/w).

Part of the biomass cake was further freeze dried and milled (6000 rpm 1 mm mesh size) to obtain the Rhizomucor pusillus biomass in powder form with a dry matter content of about 96% (w/w).

TABLE 2
Moisture and ash content of both cake and powder forms
of the Rhizomucor pusillus derived biomass.

| Composition | Biomass in cake form | Biomass in powder form |
|---|---|---|
| Moisture | 71.1 g/100 g | 4 g/100 g |
| Ash | 1 g/100 g | 3.2 g/100 g |

### Example 2: Nutritional Value of the Rhizomucor pusillus Biomass

Due to its lower moisture content (Table 2), powder derived from the Rhizomucor pusillus biomass is about 3× more concentrated than the cake alternative. The nutritional value of the Rhizomucor pusillus biomass is mainly due to its high protein and dietary fiber content (Table 3).

In addition, all nine essential amino acids are contained in the Rhizomucor pusillus biomass (Table 4). This makes the Rhizomucor pusillus derived biomass a protein source of high nutritional value in human diet. It must be taken into account that the protein content of the Rhizomucor pusillus biomass as shown in Table 3 is based on the Kjeldahl method, which is a standard method use to analyze the protein content of different food products. The Kjeldahl method is based on the total nitrogen content and uses a standard conversion factor of 6.25 to estimate the protein content in the analyzed food product. However, a conversion factor of 6.25 may not be appropriate for certain food products. In the Rhizomucor pusillus biomass, the conversion factor may be overestimated due to the presence of other nitrogen sources such as RNA, chitin and chitosan. The real protein content of the Rhizomucor pusillus biomass can for this reason better be estimated through amino acid analysis. Within the amino acids, the Rhizomucor pusillus biomass has a particularly high content of citrulline (Table 4).

TABLE 1
Nutritional value of the Rhizomucor pusillus biomass
in cake and powder form.

| | Rhizomucor | Rhizomucor | |
|---|---|---|---|
| | pusillus biomass | pusillus biomass | |
| Nutritional value | cake (29% dm) | powder (96% dm) | % DM |
| Crude protein content* | 14.3 g/100 g | 47.6 g/100 g | 49 |
| Total fat content | 2.4 g/100 g | 8.1 g/100 g | 8 |
| Total dietary fiber** | 10.6 g/100 g | 34.8 g/100 g | 37 |
| Total digestible | 0.8 g/100 g | 2.4 g/100 g | 3 |
| carbohydrates | | | |
| Total sugars | <0.5 g/100 g | <0.5 g/100 g | |
| Energy (kJoules) | 431 kJ/100 g | 1429 kJ/100 g | |
| Energy (kcal) | 103 kcal/100 g | 341 kcal/100 g | |

*Based on Kjeldahl method (N*6.25).
**Determination of the content of the total number dietary fiber method; enzymatic pre-treatment, gravimetry.

TABLE 4
Amino acid composition of the Rhizomucor pusillus
derived biomass cake

| | Rhizomucor |
|---|---|
| | pusillus biomass |
| Amino acid profile | cake (29% dm) |
| Aspartic acid (+Asparagine) | 1.04 g/100 g |
| Threonine* | 0.52 g/100 g |
| Serine | 0.52 g/100 g |
| Glutamic acid (+Glutamine ) | 1.30 g/100 g |
| Proline | 0.39 g/100 g |
| Glycine | 0.48 g/100 g |
| Alanine | 0.63 g/100 g |
| Citrulline | >1 g/100 g |
| Valine* | 0.61 g/100 g |
| Isoleucine* | 0.52 g/100 g |
| Leucine* | 0.84 g/100 g |
| Tyrosine | 0.42 g/100 g |
| Phenylalanine* | 0.47 g/100 g |
| Lysine* | 0.80 g/100 g |
| Histidine* | 0.27 g/100 g |
| Arginine | 0.63 g/100 g |
| Cysteine | 0.12 g/100 g |
| Methionine* | 0.22 g/100 g |
| Tryptophan* | 0.15 g/100 g |

*Essential amino acid for humans.

The dry matter-based dietary fiber content of the Rhizomucor pusillus biomass is extremely high, if compared to other food products known to be a good source of dietary fiber (Table 5). The dietary fiber content of the Rhizomucor pusillus biomass is even higher than the dietary fiber content of Mycoprotein, main source of Quorn® branded meat replacers (up to 95%).

TABLE 5
Dietary fiber content of the Rhizomucor pusillus biomass compared
to different foodstuff expressed as g/100 g product and % of dry matter.

| | DF* | Moisture* | | |
|---|---|---|---|---|
| Dietary Fiber (DF) content | g/100 g | g/100 g | % dm** | DF % dm** |
| Rhizomucor pusillus biomass (cake) | 10.6 | 71.1 | 29 | 37 |
| Mycoprotein (main ingredient of | 6 | 74.8 | 25 | 24 |
| Quern ® products) | | | | |
| Beans soya boiled | 13.2 | 45.1 | 55 | 24 |
| Tempeh | 5.6 | 73 | 27 | 21 |
| Kiwi | 2.3 | 83.5 | 17 | 14 |
| Miso soya paste | 6.6 | 46.8 | 53 | 12 |
| Breakfast cereals Brinta | 10.5 | 11.4 | 90 | 12 |
| Hamburger vegetarian unprep | 3.2 | 61.1 | 39 | 8 |
| Bread brown wheat | 5 | 38.6 | 61 | 8 |
| Walnuts unsalted | 4.6 | 4.5 | 96 | 5 |
| Breakfast cereals Cornflakes Kellog's | 3 | 3.6 | 97 | 3 |
| Tofu | 0.3 | 77.6 | 22 | 1 |
| Chicken fillet prepared | 0 | 64.2 | 36 | 0 |

*Data on food products other than the Rhizomucor pusillus biomass and Mycoprotein have been taken from the NEVO-online database (Nederlands Voedingstoffenbestand (NEVO): https://www.rivm.nl/nederlands-voedingsstoffenbestand. Data on Mycoprotein have been taken from: https://www.mycoprotein.org/files/nutritional-profile-of-quorn.pdf.
**Calculated.

TABLE 6
Content of chitin, chitosan and RNA in various batches
of the Rhizomucor pusillus biomass.

| | Batch 1 | Batch 2 | Batch 3 | Batch 4 | Average | Unit |
|---|---|---|---|---|---|---|
| Chitin | 8.6 | 10.8 | 9.8 | 9.9 | 9.8 | g/100 g |
| Chitosan | 9.2 | 9.5 | 8.9 | 9 | 9.2 | g/100 g |

Table 6 provides the content of chitin and chitosan in various batches of the Rhizomucor pusillus biomass. Interestingly, the Rhizomucor pusillus biomass does not only contain chitin as fiber but contains an almost equal amount of the fiber chitosan. Chitosan is the de-acetylated form of chitin and health benefits have been described for chitosan in animals. It is anticipated that also for humans chitosan will be beneficial to health [16]. As much as 9.2% (w/w) of the Rhizomucor pusillus biomass is chitosan. This contrast with Fusarium venenatum, the source of Mycoprotein, the dietary fiber of which consists of one third chitin and two thirds beta-glucan (1,3 and 1,6), according to Finnigan et al. [17].

### Example 3: Nutritional Value of a Meat Replacer Made with the Rhizomucor pusillus Biomass

A meat replacer hamburger was prepared with 28% (w/w) of the Rhizomucor pusillus biomass in cake form with 21.2% water, 32.3% textured plant protein extrudate, 1.3% tex fibres and chicken flavoring (ingredients were mixed, formed, and coated in roasting over for 35 sec at 185° C., in cook oven for 8 minutes at 170° C., freezing until a temperature of −20° C. is reached in the core). Compared to the vegetarian hamburger, the protein content of a meat replacer made with the Rhizomucor pusillus biomass (based on Kjeldahl analysis) is slightly lower (Table 7). It must be considered that the meat replacer with the Rhizomucor pusillus biomass as analyzed has been made with a biomass cake content of only 28% (w/w), which is much lower than the maximum level set for the Rhizomucor pusillus biomass when used as meat replacers (42% w/w). This means that the protein and dietary fiber content of meat replacers made with the Rhizomucor pusillus biomass can be modified according to the percentage of the Rhizomucorpusillus biomass in the final product and to the other ingredients the Rhizomucor pusillus biomass is mixed with.

TABLE 7
Nutritional value of a meat replacer made with 28% (w/w)
of the Rhizomucor pusillus biomass in cake
form compared to a plant-based vegetarian hamburger.

| | Rhizomucor | |
|---|---|---|
| | pusillus | |
| | biomass meat | Vegetarian plant- |
| Nutritional value | replacer | based hamburger* |
| Protein content | 10.4 g/100 g | 17.7 g/100 g |
| Total fat content | 6.1 g/100 g | 8.6 g/100 g |
| Total dietary fiber | 4.5 g/100 g | 3.2 g/100 g |
| Total digestible | 19.6 g/100 g | 9.4 g/100 g |
| carbohydrates | | |
| Total sugars | 1.96 g/100 g | 2.3 g/100 g |
| Energy (kJoules) | 770 kJ/100 g | 805 kJ/100 g |
| Energy (kcal) | 184 kcal/100 g | 195 kcal/100 g |

*Data have been taken from the NEVO-online database (Nederlands Voedingstoffenbestand (NEVO): https://www.rivm.nl/nederlands-voedingsstoffenbestand): Hamburger vegetarian unprepared (1511).

### Example 4: Micronutrient Content of the Rhizomucor pusillus Biomass

The Rhizomucor pusillus biomass was analyzed for micronutrient and was found to be a source of various micronutrient including different vitamins such as vitamin A, E, and vitamins of the B group and choline (see Table 8).

TABLE 8
Micronutrient content of the Rhizomucor pusillus biomass compared
to that of Mycoprotein

| | | | Rhizomucor |
|---|---|---|---|
| | Rhizomucor | | pusillus |
| | pusillus | | biomass |
| | biomass | Mycoprotein | (powder) |
| Micronutrient | (cake) mg/kg | (wet) mg/kg | mg/kg |
| Vitamin A | 0.3 | 0 | 0.9 |
| Vitamin E | 2.5 | 0 | 8.3 |
| Vitamin B1 | <0.5 | 0.1 | 0.0 |
| Vitamin B2 | 1.3 | 2.3 | 4.2 |
| Vitamin B3 | <5 | 3.5 | 0.0 |
| Vitamin B5 | <10 | 2.5 | 0.0 |
| Vitamin B6 | 0.9 | 0 | 3.1 |
| Vitamin B9 | 0.8 | 0.1 | 2.7 |
| Choline | 669 | 730 | 2225 |

The Rhizomucor pusillus biomass has a particularly high content of choline (Table 8). Choline has formerly also been referred to as vitamin B4 [6] [7]. Choline has an important function in the structural integrity of cellular membranes and in different metabolic pathways in the human body such as methyl metabolism, cholinergic neurotransmission, transmembrane signaling, transport and metabolism of lipids and cholesterol [8]. Choline can be synthesized de novo by the human body. However, choline still represents a fundamental component of human diet, since the amount produced de novo might not be enough to reach the level of Adequate Intake (AI), which is 400 mg/day for adults (both genders) [9]. In 1998, choline was recognized as essential nutrient by the Institute of Medicine (IOM) [8] [10]. Table 9 shows a comparison of the choline content of the Rhizomucor pusillus biomass with that of several types of foods.

The vitamin A content of the Rhizomucor pusillus biomass cake is 0.3 mg/kg (Table 8). Vitamin A might however also come from ingredients used in the production of the biomass (e.g. olive oil or antioxidants). However, the vitamin A content of the Rhizomucor pusillus biomass made without the use of olive oil and antioxidant still is 0.1 mg/kg, indicating that at least part of the vitamin A is produced by the fungus during the fermentation process.

The same occurs for vitamin E. Vitamin E is naturally present in olive oil (ca. 5.1 mg/100 g according to the NEVO tables) and it is likely to be present in the antioxidants as well. The vitamin E (dl-alpha tocopherol acetate) content of the Rhizomucor pusillus biomass cake is 2.5 mg/kg (Table 8). However, when the Rhizomucor pusillus biomass cake was produced without the use of olive oil and without adding antioxidants, it still has a vitamin E content of 22 mg/kg, indicating that vitamin E is produced by the fungus during the fermentation process. In this regard it is interesting to note that the vitamin E content of fungal biomass made without olive oil and antioxidant is even higher than in biomass produced in their presence.

In addition, Table 8 shows that the Rhizomucor pusillus biomass also contains various vitamins of the B group, in particular vitamin B2 (riboflavin), vitamin B6 (pyridoxine) and folate (vitamin B111, also referred to as vitamin B9 in some countries such as France, Germany and the USA).

TABLE 9
Choline content of the Rhizomucor pusillus biomass compared to different foodstuff
expressed as g/100 g product and % of dry matter.

| | Choline* | Moisture** | | Choline % |
|---|---|---|---|---|
| Choline content | mg/100 g | g/100 g | % dm*** | dm*** |
| Egg, whole, cooked, hard boiled | 230 | 76.2 | 24 | 0.97 |
| Chicken, broilers or fryers, meat | 66 | 74.1 | 26 | 0.25 |
| only, raw | | | | |
| the Rhizomucor pusillus biomass | 66.9 | 71.1 | 29 | 0.23 |
| (cake) | | | | |
| Chicken, broilers and fryers, meat | 79 | 64.2 | 36 | 0.22 |
| only, roasted | | | | |
| Soy flour, defatted | 190 | 8 | 92 | 0.21 |
| Tofu | 28 | 77.6 | 22 | 0.13 |
| Bread, whole-wheat, commercially | 27 | 35.1 | 65 | 0.04 |
| prepared | | | | |

*Reference for choline content of food other than the Rhizomucor pusillus biomass: USDA Database for the Choline Content of Common Foods, Release two (2008).
**Data on food products other than the Rhizomucor pusillus biomass have been taken from the NEVO-online database (Nederlands Voedingstoffenbestand (NEVO): https://www.rivm.nl/nederlands). The food code according to the NEVO tables is reported in brackets next to the respective food products. Data on Mycoprotein have been taken from: https://www.mycoprotein.org/files/nutritional-profile-of-quorn.pdf.
***Calculated.

### Example 5: Mineral Content of the Rhizomucor pusillus Biomass

As shown in Table 10, the Rhizomucor pusillus biomass contains high amounts of different minerals, which are added during the fermentation process and are needed for the growth of the fungus. The iron (Fe) content in the Rhizomucor pusillus biomass was particularly high and represented a limiting factor for the intake assessment according to the EFSA DRV. The iron dosage for the Rhizomucor pusillus biomass production had to be reduced to reach a final concentration of 14 mg/kg (Table 10). In addition, zinc was also reduced to a final concentration of 16 mg/kg (Table 10).

Table 11 presents a comparison of the iron content of the Rhizomucor pusillus biomass with those of various other types of food stuffs. It has to be realized that while some of the meat products in Table 11 contain a lower amount of iron, its bioavailability is higher because of the iron is present in haem-bound form.

TABLE 10
Minerals content of the Rhizomucor pusillus biomass in cake form.

| Minerals | Rhizomucor pusillus biomass | | Mycoprotein** | |
|---|---|---|---|---|
| mg/kg | Cake | Powder | wet | dry |
| Ca | 530 | 1756 | 423 | 1679 |
| Mg | 354 | 1176 | 450 | 1786 |
| P | 3058 | 10165 | 2600 | 10317 |
| K | 373 | 1236 | 1000 | 3968 |
| Zn | 16 | 54 | 90 | 357 |
| Fe | 14 | 47 | 5 | 20 |
| Cu | <5 | 0 | 5 | 20 |
| Mn | 9.7 | 32 | 6 | 24 |
| Cl | <300 | <1000 | <300 | <00 |
| Na | 146 | 516 | 5 | 20 |

TABLE 11
Iron content of the Rhizomucor pusillus biomass compared to different
foodstuff expressed as g/100 g product and % of dry matter.

| | Fe* | Moisture* | | Fe % |
|---|---|---|---|---|
| Iron (Fe) content | mg/100 g | g/100 g | % dm** | dm*** |
| Tofu | 2.2 | 77.6 | 22.4 | 0.0098 |
| Miso soya paste | 5.1 | 46.8 | 53.2 | 0.0096 |
| Beans soya boiled | 5 | 45.1 | 54.9 | 0.0091 |
| Tempeh | 2 | 73 | 27 | 0.0074 |
| Rhizomucor pusillus biomass | 1.4 | 71.1 | 29 | 0.0048 |
| in cake form | | | | |
| Beef ribeye steak prepared | 2.6 | 58.8 | 41.2 | 0.0063 |
| Hamburger vegetarian unprep | 2.1 | 61.1 | 38.9 | 0.0054 |
| Chicken fillet prepared | 0.7 | 64.2 | 35.8 | 0.002 |
| Mycoprotein** | 0.5 | 74.8 | 25.2 | 0.002 |

*Data on food products other than the Rhizomucor pusillus biomass and Mycoprotein have been taken from the NEVO-online database (Nederlands Voedingstoffenbestand (NEVO): https://www.rivm.nl/nederlands-voedingsstoffenbestand)
**Data on Mycoprotein have been taken from: https://www.mycoprotein.org/files/nutritional-profile-of-quorn.pdf.
***Calculated.

### Example 6: Lipid Content of the Rhizomucor pusillus Biomass

As shown in Table 3 above the Rhizomucor pusillus biomass contains about 9% (w/w) fat on a dry matter basis. A more detailed analysis showed that on average 22.2% (w/w) consists of saturated fatty acids, 50.1% (w/w) consists of mono-unsaturated fatty acids (mostly oleic acid) and 27.7 (w/w) consists of poly-unsaturated fatty acids (mostly linoleic acid). The Rhizomucor pusillus biomass is thus relatively rich in mono- and poly-unsaturated fatty acids.

### REFERENCES

[1] EFSA Panel on Dietetic Products, Nutrition, and Allergies (NDA), “Scientific Opinion on Dietary Reference Values for carbohydrates and dietary fiber,” 2010.
[2] P. Sharma, C. Bhandari, S. Kumar, B. Sharma, P. Bhadwal and N. Agnihotri, “Chapter 11-Dietary Fibers: A Way to a Healthy Microbiome,” in Diet, Microbiome and Health, Handbook of Food Bioengineering, 2018, pp. 299-345.
[3] EFSA Panel on Dietetic Products, Nutrition and Allergies (NDA), “Scientific Opinion on Dietary Reference Values for protein,” 2012.
[4] T. Suzuki, M. Morita, Y. Kobayashi and A. Kamimura, “Oral L-citrulline supplementation enhances cycling time trial performance in healthy trained men: Double-blind randomized placebo-controlled 2-way crossover study,” Journal of the International Society of Sports Nutrition, vol. 13, no. 6, 2016.
[5] FEDIAF (European Pet Food Industry), “Nutritional needs for cats and dogs,” 2018.
[6] T. Navarra, The Encyclopedia of Vitamins, Minerals, and Supplements, Infobase Publishing, 2004.
[7] F. Macdonald and R. L. Lundblad, Handbook of Biochemistry and Molecular Biology, Fourth edition, CRC Press, 2010.
[8] Institute of Medicine (US) Standing Committee on the Scientific Evaluation of Dietary Reference Intakes and its Panel on Folate, Other B Vitamins anch Choline, “Dietary Reference Intakes for Thiamin, Riboflavin, Niacin, Vitamin B6, Folate, Vitamin B12, Pantothenic Acid, Biotin, and Choline,” 1998.
[9] EFSA Panel on Dietetic Products, Nutrition and Allergies (NDA), “Dietary Reference Values for choline,” 2016.
[10] S. H. Zeisel and K. A. Da Costa, “Choline: An Essential Nutrient for Public Health,” Nutrition Reviews, vol. 67, pp. 615-623, 2009.
[11] FEDIAF (European Pet Food Industry), “Nutritional Guidelines For Complete and Complementary Pet Food for Cats and Dogs,” 2018.
[12] EFSA Panel on Dietetic Products, Nutrition, and Allergies (NDA), “Scientific Opinion on Dietary Reference Values for vitamin A,” 2015.
[13] EFSA Panel on Dietetic Products, Nutrition, and Allergies (NDA), “Scientific Opinion on Dietary Reference Values for vitamin E as α-tocopherol,” 2015.
[14] EFSA Panel on Dietetic Products, Nutrition and Allergies (NDA), “Dietary Reference Values for riboflavin,” 2017.
[15] EFSA Panel on Dietetic Products, Nutrition and Allergies (NDA), “Dietary Reference Values for vitamin B6,” 2016.

1. A method for increasing the content of at least one of a) protein and/or an amino acid; b) a lipid; c) dietary fiber; d) choline and/or a vitamin; and e) a mineral, in at least one of a food product, a beverage, a pet food product and a feed product, the method comprising:
a) including a composition comprising a biomass of a thermophilic fungus.

2. The method according to claim 1, wherein the composition comprising biomass of a thermophilic fungus is a cake obtainable in a process comprising the steps of a) growing a strain of a thermophilic fungus in submerged culture in a medium, b) recovery of the fungal biomass from the medium by at least one of sieving, filtration and decantation to produce a biomass cake, whereby preferably the dry matter concentration of the sieved, filtered or decanted biomass cake is at least 12% (w/v), and c) optionally, further drying the biomass cakes by pressing residual water out to obtain a biomass cake with a dry matter concentration of at least 20%.

3. The method according to claim 2, wherein the composition comprising biomass of a thermophilic fungus is a dried powder obtainable by milling and further drying the biomass cake to a biomass powder by warm air, by freeze drying, preferably under vacuum, or by flash drying, preferably to a water content of no more than 7% (w/w).

4. The method according to claim 1, wherein the fungal strain is a strain of a fungal genus selected from the group consisting of Rasamsonia, Talaromyces, Penicillium, Acremonium, Humicola, Paecilomyces, Chaetomium, Rhizomucor, Rhizopus, Thermomyces, Myceliophthora, Thermoascus, Thielavia, Mucor, Stibella, Melanocarpus, Malbranchea, Dactylomyces, Canariomyces, Scytalidium, Myriococcum, Corynascus, and Coonemeria, more preferably the genus is Rhizomucor, more preferably the strain is a Rhizomucor pusillus, most preferably the strain is Rhizomucor pusillus CBS 143028, or a strain that is a single colony isolate or a derivative thereof.

5. The method according to claim 1, wherein at least one of the protein and/or amino acid comprise an amino acid selected from the group consisting of aspartic, acid, asparagine, threonine, serine, glutamic acid, glutamine, proline, glycine, alanine, citrulline, valine, isoleucine, leucine, tyrosine, phenylalanine, lysine, histidine, arginine, cysteine, methionine and tryptophan, wherein preferably the amino acid is an essential amino acid, more preferably an essential amino acid selected from the group consisting of threonine, valine, isoleucine, leucine, phenylalanine, lysine, histidine, methionine and tryptophan, most preferably, in a vegetarian and vegan food product.

6. The method according to claim 5, wherein:
a) the biomass of the thermophilic fungus biomass is a (dietary) source of at least one of protein, amino acids and essential amino acids in a vegetarian or a vegan food product;
b) the biomass of a thermophilic fungus is a (dietary) source citrulline in food, a food supplement or a beverage for sporting people; or
c) the biomass of a thermophilic fungus is a source of protein, amino acids and essential amino acids in a pet food, preferably as alternative to standard animal or plant-based sources of protein, amino acids in pet food more preferably as sole source of protein and/or amino acids.

7. The method according to claim 1, wherein the biomass of the thermophilic fungus is a source of dietary fiber to enrich the fiber content of a food product selected from: i) a meat replacer; ii) a hybrid food product containing meat and non-meat ingredients; iii) a carbohydrate-rich food product; iv) a bakery product made with refined flours; and v) a pet food, wherein preferably the dietary fiber comprises chitosan.

8. The method according to claim 7, wherein the biomass of the thermophilic fungus is a source of dietary fiber in a human or pet food product to provide satiety, preferably to a human or pet in need of weight management or weight loss, wherein preferably the dietary fiber comprises chitosan.

9. The method according to claim 1, wherein the biomass of the thermophilic fungus is a source of choline in a vegan or vegetarian food product, or in a pet food, preferably a cat or dog food.

10. The method according to claim 1, wherein the biomass of the thermophilic fungus is provided as a source of at least one of retinol, vitamin E, riboflavin, pyridoxine and folate, wherein preferably the biomass is provided as a source of retinol in cat food.

11. The method according to claim 1, wherein the biomass of the thermophilic fungus is a source of iron, preferably, the biomass of the thermophilic fungus is provided to replace soya as source of iron, more preferably, the biomass of the thermophilic fungus is provided to replace soya as source of iron in a meat replacer.

12. The method according to claim 1, wherein the biomass of the thermophilic fungus is provided as a source of at least one of mono-unsaturated fatty acids and poly-unsaturated fatty acids, preferably, the biomass thermophilic fungus is provided as a source of at least one of oleic acid and linoleic acid.

13. The method according to claim 1, wherein the biomass of the thermophilic fungus is at a maximum level of 70% (w/w) and at a minimum level of at least 1% (w/w), in either cake or powder form in a food product, a beverage, a pet food product and a feed product.

14. The method according to claim 1, wherein the biomass of the thermophilic fungus is an ingredient for:
a) a meat replacer, wherein the meat replacer comprises no more than 42% (w/w) of the biomass of the thermophilic fungus in cake form, or no more than 14% (w/w) of the biomass of the thermophilic fungus in powder form;
b) a hybrid meat product, wherein the hybrid meat product comprises no more than 52% (w/w) of the biomass of the thermophilic fungus in cake form, or no more than 17.3% (w/w) of the biomass of the thermophilic fungus in powder form;
c) a cereal-based food product, wherein the cereal-based food product comprises no more than 30% (w/w) of the biomass of the thermophilic fungus in cake form, or no more than 10% (w/w) of the biomass of the thermophilic fungus in powder form;
d) a ready to eat meal food product, wherein the ready to eat meal food product comprises no more than 16% (w/w) of the biomass of the thermophilic fungus in cake form, or no more than 5.3% (w/w) of the biomass of the thermophilic fungus in powder form;
e) a ready to eat soup, wherein the ready to eat soup comprises no more than 27% (w/w) of the biomass of the thermophilic fungus in cake form, or no more than 9% (w/w) of the biomass of the thermophilic fungus in powder form; and,
f) a food product for sporting people, the food product for sporting people comprises no more than 70% (w/w) of the biomass of the thermophilic fungus in cake or in powder form.

15. A food product comprising a composition comprising biomass of a thermophilic fungus as defined in claim 1, wherein the food product is:
a) a meat replacer, wherein the meat replacer comprises no more than 42% (w/w) of the biomass of the thermophilic fungus in cake form, or no more than 14% (w/w) of the biomass of the thermophilic fungus in powder form;
b) a hybrid meat product, wherein the hybrid meat product comprises no more than 52% (w/w) of the biomass of the thermophilic fungus in cake form, or no more than 17.3% (w/w) of the biomass of the thermophilic fungus in powder form;
c) a cereal-based food product, wherein the cereal-based food product comprises no more than 30% (w/w) of the biomass of the thermophilic fungus in cake form, or no more than 10% (w/w) of the biomass of the thermophilic fungus in powder form;
d) a ready to eat meal food product, wherein the ready to eat meal food product comprises no more than 16% (w/w) of the biomass of the thermophilic fungus in cake form, or no more than 5.3% (w/w) of the biomass of the thermophilic fungus in powder form;
e) a ready to eat soup, wherein the ready to eat soup comprises no more than 27% (w/w) of the biomass of the thermophilic fungus in cake form, or no more than 9% (w/w) of the biomass of the thermophilic fungus in powder form; and,
f) a food product for sporting people, the food product for sporting people comprises no more than 70% (w/w) of the biomass of the thermophilic fungus in cake or in powder form.
